(19) United States
(12) Patent Application Publication
(10) Pub. No.: US 2026/0129121 A1
(43) Pub. Date: May 7, 2026

(54) DEVICE, SYSTEM AND METHOD FOR CONTROLLING ARTIFICIAL INTELLIGENCE USAGE

(71) Applicant: MOTOROLA SOLUTIONS, INC., Chicago, IL (US)

(72) Inventors: Bing Qin LIM, Bayan Lepas (MY); Brian J. FROMMELT, Darien, IL (US); Brandon CHRISTENSEN, Salt Lake City, UT (US)

(21) Appl. No.: 18/940,579

(22) Filed: Nov. 7, 2024

(51) Int. Cl. H04M 3/51; G06N 20/00

(52) U.S. Cl. CPC H04M 3/5116; G06N 20/00; H04M 2242/04

(57) ABSTRACT

A computing device determines a relative weightage of human-in-the-loop component usage to artificial intelligence component usage in a computing process that includes human decision-making and artificial intelligence decision-making. When the relative weightage is below a given range, such that the human-in-the-loop component usage is low relative to the artificial intelligence component usage: the computing device adjusts the computing process to increase the human-in-the-loop component usage relative to the artificial intelligence component usage. When the relative weightage is above the given range, such that the human-in-the-loop component usage is high relative to the artificial intelligence component usage: the computing device adjusts the computing process to decrease the human-in-the-loop component usage relative to the artificial intelligence component usage

### BACKGROUND OF THE INVENTION

The increasing integration of artificial intelligence (AI) in public safety (PS) agencies, and other types of agencies, has introduced complex technical challenges in managing AI usage. PS agencies may rely on AI to assist with decision-making in high-stakes environments such as 911 dispatch centers and law enforcement operations. Similarly, medical personnel may rely on AI to assist with medical diagnoses, and the like. However, how often AI is used, especially in critical situations, such as public safety incidents, remains a significant technical challenge.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for controlling artificial intelligence usage, in accordance with some examples.

FIG. 2 is a device diagram showing a device structure of a computing device for controlling artificial intelligence usage, in accordance with some examples.

FIG. 3 is a flowchart of a method for controlling artificial intelligence usage, in accordance with some examples.

FIG. 4 depicts a portion of the system of FIG. 1 implementing aspects of a method for controlling artificial intelligence usage, in accordance with some examples.

FIG. 5 depicts the portion of the system of FIG. 1 continuing to implement aspects of a method for controlling artificial intelligence usage, in accordance with some examples.

FIG. 6 depicts the portion of the system of FIG. 1 continuing to implement aspects of a method for controlling artificial intelligence usage, in accordance with some examples.

FIG. 7 depicts a dashboard providing indications of adjustments of artificial intelligence usage for a plurality of computing processes and at different stages of an incident response.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Ensuring human oversight in AI-driven decisions may be crucial to prevent errors in scenarios that impact public safety environments and/or in other environments. Additionally, the balance between human involvement and AI assistance must be carefully controlled. Over-reliance on AI may result in inappropriate actions, while insufficient use of AI can reduce the efficiency of operations.

Thus, there exists a need for an improved technical method, device, and system for controlling artificial intelligence usage.

In particular, provided herein is a device, system and method for controlling artificial intelligence usage, and in particular for controlling a relative weightage of human-in-the-loop component usage to artificial intelligence component usage in a computing process that includes human decision-making and artificial intelligence decision-making.

An aspect of the present specification provides a method comprising: determining, at a computing device, a relative weightage of human-in-the-loop component usage to artificial intelligence component usage in a computing process that includes human decision-making and artificial intelligence decision-making; when the relative weightage is below a given range, such that the human-in-the-loop component usage is low relative to the artificial intelligence component usage: adjusting, via the computing device, the computing process to increase the human-in-the-loop component usage relative to the artificial intelligence component usage; and when the relative weightage is above the given range, such that the human-in-the-loop component usage is high relative to the artificial intelligence component usage: adjusting, via the computing device, the computing process to decrease the human-in-the-loop component usage relative to the artificial intelligence component usage.

Another aspect of the present specification provides a computing device comprising: a controller; and a computer-readable storage medium having stored thereon program instructions that, when executed by the controller, causes the controller to perform a set of operations comprising: determining a relative weightage of human-in-the-loop component usage to artificial intelligence component usage in a computing process that includes human decision-making and artificial intelligence decision-making; when the relative weightage is below a given range, such that the human-in-the-loop component usage is low relative to the artificial intelligence component usage: adjusting the computing process to increase the human-in-the-loop component usage relative to the artificial intelligence component usage; and when the relative weightage is above the given range, such that the human-in-the-loop component usage is high relative to the artificial intelligence component usage: adjusting the computing process to decrease the human-in-the-loop component usage relative to the artificial intelligence component usage.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

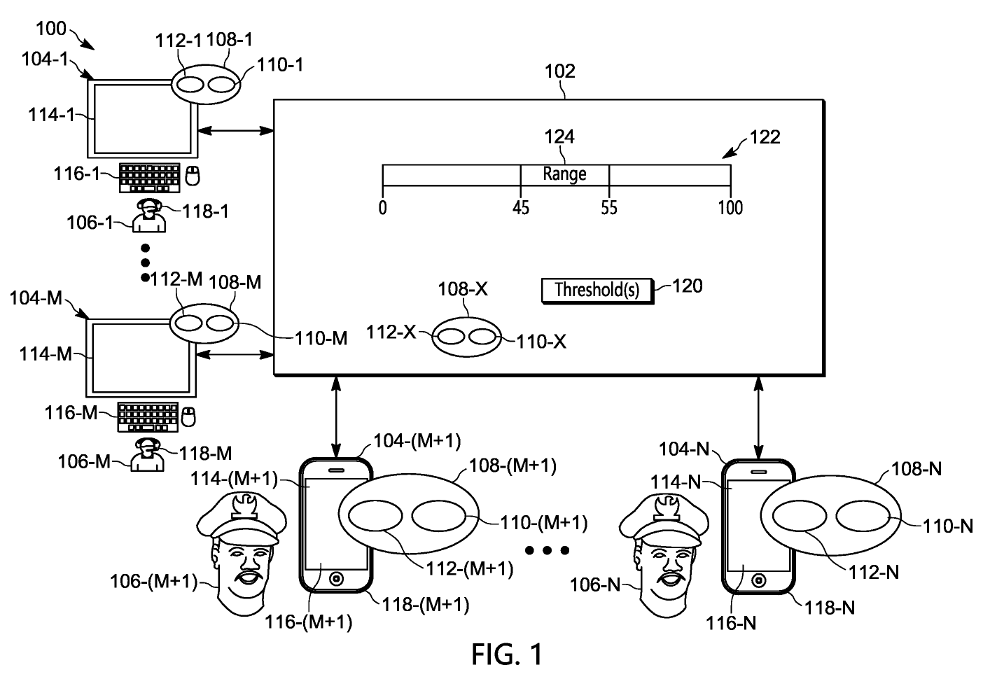

Attention is directed to FIG. 1, which depicts an example system 100 for controlling artificial intelligence usage. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a computing device 102, and an “N” number of client devices 104-1….104-M, 104-(M+1)…104-N operated by respective human users 106-1….106-M, 106-(M+1)…106-N. For simplicity, the client devices 104-1….104-M, 104-(M+1)…104-N are interchangeably referred to hereafter, collectively, as the client devices 104 and, generically, as a client device 104. This convention will be used elsewhere in the present specification. For example, the human users 106-1….106-M, 106-(M+1)…106-N are interchangeably referred to hereafter, collectively, as users 106 and, generically, as a user 106.

The number "N" of the client devices 104 and respective users 106 may be any suitable number, and may be as low as one client device 104 and a respective user 106 (e.g., N=1), but may be tens, hundreds, or thousands of client devices 104 and respective users 106.

Furthermore, as depicted, the client devices 104 are implementing respective applications 108-1….108-M, 108-(M+1)…108-N, that include respective human-in-the loop (HIL) components 110-1….110-M, 110-(M+1)…110-N and respective artificial intelligence (AI) components 112-1….112-M, 112-(M+1)…112-N.

As depicted, the computing device 102 may furthermore implement one or more respective applications 108-X that include respective HIL components 110-X and respective AI components 112-X.

The applications 108-1….108-M, 108-(M+1)…108-N, 108-X are interchangeably referred to hereafter as the applications 108 and/or an application 108, the human-in-the loop (HIL) components 110-1….110-M, 110-(M+1)…110-N, 110-X are interchangeably referred to hereafter as the HIL components 110 and/or an HIL component 110, and the respective AI components 112-1….112-M, 112-(M+1)…112-N, 112-X are interchangeably referred to hereafter as the AI components 112 and/or an AI component 112.

It is further understood that one or more of the applications 108 may be hosted at the computing device 102 as an application 108-X.

Hence, an application 108 for a respective client device 104 (e.g., whether the application 108 is implemented by the client device 104 or hosted by the computing device 102) is understood to comprise a computing process that relies at least partially on human input via a respective HIL component 110, such that a respective user 106 may interact with the application 108 via the respective HIL component 110 to control the application 108. In particular, the respective user 106 may make decisions on how to control the application 108, and the like, and interact with the application 108 via the respective HIL component 110.

However, a computing process of an application 108, for a respective client device 104 (e.g., whether the application 108 is implemented by the client device 104 or hosted by the computing device 102), may furthermore rely at least partially on decisions made by a respective AI component 112, such that a respective user 106 may be at least partially obviated from making decisions on how to control the application 108. However, in some examples, decisions made by a respective AI component 112 may be confirmed and/or accepted by a respective user 106 via respective HIL component 110. In some examples, the computing device 102 and/or a respective client device 104, may track and/or determine a time period from when a decision made by a respective AI component 112 is presented to a user 106, for example at a display screen of the respective client device 104, to when that decision is confirmed by the respective user 106 via the respective HIL component 110,

Hence, an application 108 for a respective computing device 102 is understood to rely at least partially on human input and/or human-made decisions via a respective HIL component 110 and at least partially rely on AI-made decisions via a respective AI component 112.

As depicted the client devices 104-1….104-M may comprise terminals, and the client devices 104-(M+1)…104-N may comprise mobile devices. However, the client devices 104 are understood to include any suitable type of client device 104 including, but not limited to, terminals, personal computers, laptops, mobile devices, cell phones, tablets, and the like.

Furthermore, in the depicted example, the system 100 may be implemented by a public safety agency, and more specifically a police entity, however the system 100 may be implemented by any suitable entity, including, but not limited to, a firefighting agency, an emergency medical technician entity and/or any other suitable public safety agency. In such examples, the computing device 102 may be a component of a public safety answering point (PSAP), and the users 106-1 to 106-M may be PSAP operators. However the system 100 may alternatively be operated by entities other than public safety agencies, including, but not limited to, government entities, public and/or private medical entities, public and/or private hospital entities, public and/or private educational entities, public and/or private first responder entities, public and/or private business entities, and the like. The client devices 104 and/or the applications 108 may hence be adapted for functionality associated with an entity implementing the system 100, and the users 106 may comprise any suitable persons associated with such an entity.

Using a police agency as an example of an entity implementing the system 100, the terminals of the client devices 104-1….104-M may comprise PSAP terminals, and/or dispatch terminals, and the like, and the users 106-1….106-M may comprise PSAP operators and/or dispatchers, and the like.

Similarly, the mobile devices of the client devices 104-(M+1)….104-N may comprise cell phones and/or radios (including, but not limited to vehicle radios) adapted for use by police officers, and the like, and the users 106-(M+1)….106-N may comprise police officers, and the like.

In another example of a medical entity implementing the system 100, the client devices 104 may comprise computers and/or terminals used to review medical data of patients and determine diagnoses based on the medical data, and the users 106 may be doctors, nurses and/or any other suitable medical personnel, and the like.

As depicted, a client device 104 may comprise respective display screens 114-1…114-M…114-(M+1)...114-N (e.g., display screens 114 and/or a display screen 114) and respective input devices 116-1…116-M…116-(M+1)...116-N (e.g., input devices 116 and/or an input device 116), such as a keyboard and pointing device (e.g., a mouse), in the case of the terminals and/or a touch screen integrated with a display screen 114 in the case of the mobile devices, and/or any other suitable input device and/or combination thereof.

In general, the display screens 114 and the input devices 116 may be operated by a respective user 106 to interact with a respective HIL component 110 of a respective application 108, and/or to view and/or confirm decisions made by a respective AI component 112, for example via graphic user interface (GUI) (not depicted) provided at the display screen 114 that may represent a respective application 108.

Furthermore, at least in the case of the terminals, the components of the terminals may be provided in any suitable format, such as a laptop, a personal computer, and the like (e.g., when a respective user 106 is working from home and/or “off-premises” from a PSAP, and the like).

As depicted, the client devices 104 may further comprise communication components 118-1…118-M…118-(M+1)...118-N (e.g., communication components 118 and/or a communication component 118), for example as represented in FIG. 1 at the terminals by headsets worn by the respective users 106, and/as speaker/microphone combinations at the mobile devices), such that respective users 106 may communicate with other client devices 104, make and/or receive phone calls, and/or other types of communications, including, but not limited to, talkgroup and/or push-to-talk communications, and the like.

Aspects of the applications 108, the HIL components 110 and the AI components 112 are next described.

For example, any given application 108 may be specific to a given type of entity that operates the system 100 and/or a role of a respective user 106.

Using the example of a police agency operating the system 100, and the users 106 of the terminals being PSAP operators and/or dispatchers, and the like, an associated application 108 may comprise a dispatch application and/or an incident management application used to answer calls to a PSAP, dispatch police officers to incidents and/or manage incidents, and the like. Alternatively, or in addition, an associated application 108 may comprise a crime analysis application, a workflow implementation application (e.g., such Orchestrate™ from Motorola Solutions Inc.), and/or any other suitable application implemented in conjunction with a PSAP and/or police dispatch.

In these examples, the HIL components 110 may be operated by respective users 106 to answer calls, generate incident reports, assign officers to incidents, dispatch officers to incidents, analyze crime statistics, implement crime-prevention workflows, and the like. In addition, respective AI components 112 may be used to answer calls, generate incident reports, assign officers to incidents, dispatch officers to incidents, analyze crime statistics, implement crime-prevention workflows, and the like. In other words, at least some of the functionality of the HIL components 110 that may be manually implemented, may be implemented by the respective AI components 112. In some examples, determinations made by an AI component 112 may be provided to a user 106 via respective display screen 114, and an HIL component 110 may be used to accept or reject the AI determinations (e.g., such as accepting or rejecting a determination of an incident type and/or accepting or rejecting a determination of how many, and/or which officers, to assign and/or dispatch to an incident, and the like), with a time period for accepting, or rejecting, an AI determination being tracked by a respective client device 104 and/or the computing device 102.

In another example, using the example of a police agency operating the system 100, and the users 106 of the mobile devices being police officers, and the like, an associated application 108 may comprise an incident reporting application, in which the officers may write reports detailing their role and/or observations and/or events for a particular incident.

In these examples, the HIL components 110 may be operated by respective users 106 to write the incident reports, associate words with media collected by the user 106 when responding to (and/or investigating) an incident, such as body-worn camera (BWC) video, and the like. In addition, respective AI components 112 may be used to assist at writing the incident reports, to fill in words, associate words with the media collected by the user 106 when responding to (and/or investigating) an incident. In other words, at least some of the functionality of the HIL components 110 that is manually implemented, may be implemented by the respective AI components 112. In some examples, determinations made by an AI component 112 may be provided to a user 106 via respective display screen 114, and an HIL component 110 may be used to accept or reject the AI determinations (e.g., such as accepting or rejecting given words and/or associations, and the like), with a time period for accepting, or rejecting, an AI determination being tracked by a respective client device 104 and/or the computing device 102.

In another example, in this scenario, an application 108 may comprise a navigation application, and an HIL component 110 and/or an AI component may be used to determine a route to an incident, and the like, which may optionally be accepted or rejected by a user 106 via an HIL component 110, with a time period for accepting, or rejecting, an AI determination of the route being tracked by a respective client device 104 and/or the computing device 102.

In yet another example of medical entity operating the system 100, and a user 106 of a client device 104 being a doctor (e.g., such as a radiologist) reviewing medical data of patient (e.g., such as bloodwork, X-Ray images, magnetic resonance imaging (MRI) images, and the like), an associated application 108 may comprise a medical application for reviewing the medical data to diagnose the patient, and the like.

In these examples, the HIL components 110 may be operated by respective users 106 to view the medical data and enter a diagnosis determined by the user 106, and the like. In addition, respective AI components 112 may be used to analyze the medical data and determine a diagnosis, which may be provided to the user 106 via respective display screen 114, and an HIL component 110 may be used to accept or reject the AI determined diagnosis, with a time period for accepting, or rejecting, the AI determined diagnosis being tracked by a respective client device 104 and/or the computing device 102. In other words, at least some of the functionality of the HIL components 110 that is manually implemented, may be implemented by the respective AI components 112.

It is further understood that such examples of functionality of the applications 108 and/or the components 110, 112 are not meant to be exhaustive, and any suitable functionality of the applications 108 and/or the components 110, 112 is within the scope of the present specification. Indeed, as AI is increasingly being integrated for decision-making in computing devices, other types of functionality of the applications 108 and/or the components 110, 112 may occur to persons of skill in the art.

Furthermore, some applications 108 may be implemented by more than one client device 104, and a client device 104 may implement more than one application 108.

It is furthermore understood that an AI component 112 may be implemented upon receiving a command via a respective HIL component 110. Returning to the example of the terminals and the PSAP operators, when a call is received at a terminal and a respective PSAP operator is busy, the PSAP operator may interact with a respective HIL component 110 to cause the respective AI component 112 to answer the call.

However, in other examples, an AI component 112 may be automatically engaged based on one or more respective thresholds 120. Returning to the example of the client devices 104 comprising terminals and the users 106 comprising PSAP operators, when calls are received at a PSAP of which the terminals are components, and a given threshold number and/or percentage of the PSAP operators are otherwise engaged in respective calls and/or when a number of calls reaches a given threshold number of calls, AI components 112 may automatically begin answering at least a portion of the calls. Hence, the respective thresholds 120 may include, but are not limited to, the given threshold number and/or percentage of the PSAP operators and/or the given threshold number of calls, and the like. While the respective thresholds 120 are depicted at the computing device 102, it is understood that the respective thresholds 120 may be stored at the client devices 104 and/or updated at the client devices 104 by the computing device 102 and/or retrieved by the client devices 104 from the computing device 102, and the like.

Furthermore, the one or more respective thresholds 120 may comprise any suitable type of threshold and may be based on one or more of a stress level of a user 106 (e.g., presuming a user 106 is wearing a stress tracking and/or fitness tracking device that communicates a stress level to an associated client device 104 and/or the computing device 102), workload, incident type, task type, and the like.

For example, presuming a user 106 is wearing a stress tracking and/or fitness tracking device that communicates a stress level to an associated client device 104 and/or the computing device 102, an AI component 112 may be controlled to perform certain functionality when the stress level of the user 106 is above a respective stress threshold 120.

Similarly, presuming a workload of a user 106 is being tracked at a computing device 102 (e.g., via workload determination application, which may be a component of an application 108 and/or a different application), an AI component 112 may be controlled to perform certain functionality when the workload of the user 106 is above a respective workload threshold 120.

Furthermore, particular thresholds 120 may be associated with different types of applications 108 and/or different types of incident types, task types implemented by an application 108, and the like. For example, when an incident comprises a murder incident, a report writing application 108 may use one threshold 120 to implement a respective AI component 112, and when an incident comprises a jay-walking incident, a report writing application 108 may use a second threshold 120, higher than the first threshold 120, to implement a respective AI component 112. For example, for a murder incident, a first workload related threshold 120 may be lower than a second workload related threshold 120 for a jay-walking incident. For example, a respective AI component 112 may be implemented to offload some manual report writing tasks to the respective AI component 112 to relieve stress of the user 106.

Put another way, for a murder incident, an AI component 112 may be implemented when workload of a respective user 106 is above a first workload related threshold 120 that is lower than a second workload related threshold 120 for a jay-walking incident, as it may be more critical to relieve workload to better, and/or more accurately, capture details of a murder incident than a jay-walking incident.

Similarly, a first stress related threshold 120 may be lower for a navigation task than for second stress related threshold 120 for a reporting task, as it may be more critical to relieve stress when navigating to an incident than when writing an incident report. Put another way, for a navigation task, an AI component 112 may be implemented when stress of a respective user 106 is above a first workload stress related threshold 120 that is lower than a second stress related threshold 120 for a report writing task, as it may be more likely that lower stress may lead to inaccurate navigation than higher stress leads to inaccurate report writing.

Hence it is understood that different thresholds 120 may be used for different types of applications 108 and/or for different functionality of the applications 108.

However, any suitable threshold 120 for implementing an AI component 112 is within the scope of the present specification.

The computing device 102 may furthermore communicate with the client devices 104 to determine a relative weightage of human-in-the-loop component usage to artificial intelligence component usage in a computing process that includes human decision-making and artificial intelligence decision-making.

Put another way, the applications 108 are understood to implement respective computing processes, for example to implement given functionality as has been previously described, and such computing processes may include human decision-making via respective HIL component 110 usage, and artificial intelligence decision-making via respective AI component 112 usage.

The client devices 104 may report, to the computing device 102, any suitable data that enables the computing device 102 to determine the relative weightage of human-in-the-loop component usage to artificial intelligence component usage, which may include, but is not limited to, respective numbers of decisions made by respective HIL components 110 and respective AI components 112, time periods in which respective HIL components 110 and respective AI components 112 were used, and the like. In particular, such time periods may further comprise the aforementioned time periods that a respective HIL component 110 was used to accept (or reject) a decision of a respective AI component 112 (e.g., how long a user 106 took to review and accept a proposed AI decision); for example, the longer a user 106 takes to review and accept a proposed AI decision, the higher the HIL component usage may be relative to respective AI component usage.

In some examples, the relative weightage may comprise a percentage (e.g., in a range of 0 (e.g., 0%) to 100 (e.g., 100%)) of human-in-the-loop component usage as compared to artificial intelligence component usage. However, the relative weightage may be determined in any suitable format, including, but not limited to fractional relative weightage in range of 0 to 1. For example, at a percentage of 0% it is understood that there is no human-in-the-loop component usage, and artificial intelligence component usage may be at 100%. Conversely, at a percentage of 100% it is understood that there is no artificial intelligence component usage, and human-in-the-loop component usage may be at 100%.

In particular, as depicted, the computing device 102 may store and/or otherwise have access to, a scale 122 (e.g., of a range of “0” to “100”) of relative weightage of human-in-the-loop component usage to artificial intelligence component usage that include a given range 124 (e.g., as depicted “45” to “55”) within which the relative weightage is to be maintained. For example, the given range 124 may be defined by the entity operating the system 100 and/or by a government and/or legislation (e.g., which may restrict AI usage in police decision making to be within the given range 124, for example).

Furthermore, it is understood that the inverse of the relative weightage of human-in-the-loop component usage to artificial intelligence component usage may be determined instead (e.g. relative weightage of artificial intelligence component usage to human-in-the-loop component usage), with the given range 124 adapted accordingly. Put another way, determining the relative weightage of human-in-the-loop component usage to artificial intelligence component usage may comprise determining the inverse of the relative weightage.

Furthermore, different given ranges 124 may be used for different types of applications 108 and/or for different functionality of the applications 108. For example, a given range 124 associated with a report writing application 108 may be higher and/or wider than a respective given range 124 of an application 108 that determines a type of incident and/or selects police officers for dispatch to an incident, and the like. Similarly, a given range 124 associated with a medical diagnosis application 108 may be lower and/or narrower than a respective given range 124 of a medical report writing application 108, and the like.

In general, the computing device 102 may be generally configured to control usage of the AI components 112, and/or a type of AI used by the AI components 112, and the like, to maintain the relative weightage of human-in-the-loop component usage to artificial intelligence component usage within the given range 124.

For example, when the relative weightage is below the given range 124, such that the human-in-the-loop component usage is low relative to the artificial intelligence component usage, the computing device 102 may adjust a computing process of an application 108 to increase the human-in-the-loop component usage relative to the artificial intelligence component usage, for example until the relative weightage is within the given range 124. Such adjustment may decrease AI component usage, relative to human-in-the-loop component usage, which may ensure that AI decisions are not overly relied on in the system 100.

Conversely, when the relative weightage is above the given range 124, such that the human-in-the-loop component usage is high relative to the artificial intelligence component usage, the computing device 102 may adjust the computing process of the application 108 to decrease the human-in-the-loop component usage relative to the artificial intelligence component usage, for example until the relative weightage is within the given range 124. Such adjustment may increase AI component usage, relative to human-in-the-loop component usage, to increase efficiency of operations of the system 100.

Put another way, when human-in-the-loop component usage is “too low” relative to AI component usage, and/or AI component usage is “too high” relative to human-in-the-loop component usage, then human-in-the-loop component usage may be increased and/or AI component usage may be decreased to bring the relative weightages into the give range 124. Similarly, when human-in-the-loop component usage is “too high” relative to AI component usage, and/or AI component usage is “too low” relative to human-in-the-loop component usage, then human-in-the-loop component usage may be decreased and/or AI component usage may be increased to bring the relative weightages into the give range 124.

Such adjustment may occur in any suitable manner, for example by increasing or decreasing a respective threshold 120, activating or deactivating one or more given artificial intelligence based features of the computing process (e.g., and more specifically a respective AI component 112), changing a type of artificial intelligence algorithm used in the computing process (e.g., and more specifically a respective AI component 112), and the like.

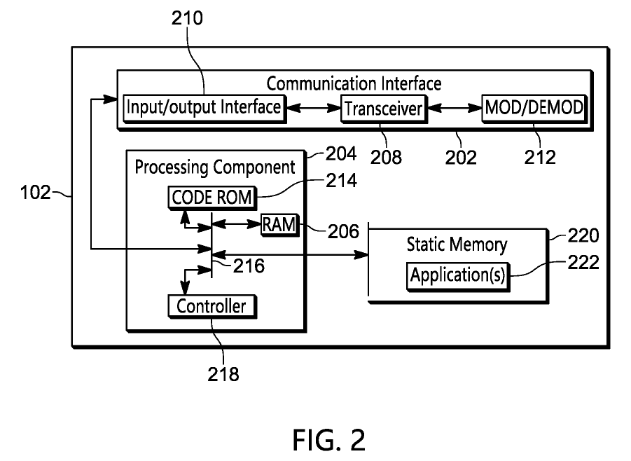

Attention is next directed to FIG. 2, which depicts a schematic block diagram of an example of the computing device 102.

While the computing device 102 is depicted in FIG. 2 as a single component, the computing device 102 may be distributed among a plurality of components and the like including, but not limited to, any suitable combination of one or more servers, one or more cloud computing devices, and the like.

As depicted, the computing device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 102 may have any suitable structure and/or configuration.

While not depicted, the computing device 102 may include, and/or be in communication with, one or more of a display screen and an input component (and/or any other suitable combination of input and/or output components) and the like, such as one or more of the display screens 114 and the input devices 116.

As shown in FIG. 2, the computing device 102 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via wireless radio network.

It is understood that while DMR transceivers, P25 transceivers, and TETRA transceivers may be particular to first responders and/or public service officers, in some examples, the system 100 may be operated by a first responder entity and/or a public service entity (e.g., such as a police department, a fire department, an emergency medical services department, and the like), and hence such transceivers may be used for communications.

The communication interface 202 may further include one or more wireline transceivers 208, such as an Ethernet transceiver, a USB (Universal Serial Bus) transceiver, or similar transceiver configurable to communicate via twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the computing device 102 is not a generic controller and/or a generic device, but a device specifically configured to implement functionality for controlling artificial intelligence usage. For example, in some examples, the computing device 102 and/or the controller 218 specifically comprises a computer executable engine configured to implement functionality for controlling artificial intelligence usage.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 102 as described herein are maintained, persistently, at the memory 220 and used by the controller 218, which makes appropriate utilization of volatile storage during the execution of such programming instructions.

Regardless, it is understood that the memory 220 stores instructions corresponding to the at least one application 222 that, when executed by the controller 218, enables the controller 218 to implement functionality particular to the computing device 102.

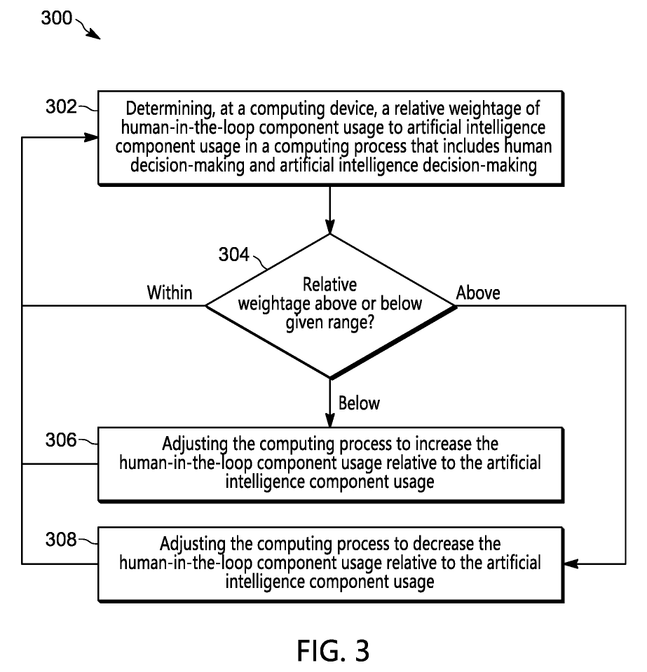

For example, the memory 220 stores instructions corresponding to the at least one application 222 that, when executed by the controller 218, enables the controller 218 to implement functionality, including, but not limited to, certain blocks of the method set forth in FIG. 3.

The application 222 may include programmatic algorithms, and the like, to implement functionality as described herein.

Alternatively, and/or in addition to programmatic algorithms, the application 222 may include one or more machine learning algorithms to implement functionality as described herein.

For example, relative weightage may be determined using programmatic algorithms and/or one or more machine learning algorithms, and/or functionality for adjusting the relative weightage may be implemented using programmatic algorithms and/or one or more machine learning algorithms. Such one or more machine learning algorithms may include, but are not limited to, one or more of: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

It is furthermore understood however, that such one or more machine learning algorithms may be different from AI features and/or AI algorithms of the AI components 112, as described herein.

Furthermore, while not depicted, the memory 220 may store the one or more thresholds 120, the scale 122 and/or the given range 124, for example as components of the application 222. Furthermore, while not depicted, the memory 220 may store any suitable programming instructions for implementing the applications 108-X and/or hosting an application 108.

While components of the client devices 104 are not shown, it is understood that components of the client devices 104 may have a similar structure to components of the computing device 102, but adapted for the functionality of the client devices 104 as described herein.

Attention is next directed to FIG. 3, which depicts a method for controlling artificial intelligence usage. The operations of the method 300 correspond to machine readable instructions that are executed by the controller 218 and/or the computing device 102. In the illustrated example, the instructions represented by the blocks of FIG. 3 are stored at the memory 220 for example, as the application 222. The method 300 of FIG. 3 is one way in which the controller 218 and/or the computing device 102 and/or the system 100 may be configured. Furthermore, the following discussion of the method 300 of FIG. 3 will lead to a further understanding of the system 100, and its various components.

The method 300 need not be performed in the exact sequence as shown and likewise various blocks may be performed in parallel rather than in sequence. Accordingly, the elements of method 300 are referred to herein as “blocks” rather than “steps”. The method 300 may be implemented on variations of the system 100 of FIG. 1, as well.

Furthermore, while FIG. 3 is described herein with respect to the computing device 102 implementing the method 300, the method 300 may be implemented by one or more of the client devices 104, for example to control respective relative weightage of human-in-the-loop component usage to artificial intelligence component usage for a computing process of a respective application 108.

At a block 302, the controller 218, and/or the computing device 102, determines a relative weightage of human-in-the-loop component usage to artificial intelligence component usage in a computing process that includes human decision-making and artificial intelligence decision-making.

At a block 304, the controller 218, and/or the computing device 102, determines whether the relative weightage is above or below the given range 124, or within the given range 124.

When the relative weightage is below the given range 124 (e.g., “BELOW” at the block 304), such that the human-in-the-loop component usage is low relative to the artificial intelligence component usage, at a block 306, the controller 218 and/or the computing device 102, adjusts the computing process to increase the human-in-the-loop component usage relative to the artificial intelligence component usage.

When the relative weightage is above the given range 124 (e.g., “ABOVE” at the block 304), such that the human-in-the-loop component usage is high relative to the artificial intelligence component usage, at a block 306, the controller 218 and/or the computing device 102 adjusts the computing process to decrease the human-in-the-loop component usage relative to the artificial intelligence component usage.

Indeed, at the block 306 and/or the block 308, the controller 218 and/or the computing device 102, may adjust the computing process until the relative weightage is within the given range 124, and/or at the block 306 and/or the block 308, the controller 218 and/or the computing device 102, may adjust the computing process and the method 300 repeats from the block 302 until the relative weightage is within the given range 124, for example in a feedback loop.

Furthermore, when the relative weightage is within the given range 124 (e.g., “WITHIN” at the block 304), the method 300 repeats from the block 302, for example to continue to monitor the relative weightage.

Further aspects of the method 300 will next be described.

For example, adjusting the computing process to increase the human-in-the-loop component usage relative to the artificial intelligence component usage (e.g., at the block 306) may comprise the controller 218, and/or the computing device 102: increasing a threshold 120 in the computing process for implementing an artificial intelligence component 112. In particular a threshold 120 may be increased such that an artificial intelligence component 112 is less likely to be implemented, and respective functionality is hence implemented via a respective HIL component 110. For example, a threshold of a number of calls (e.g., pending 911 calls at a PSAP) may be increased such that an artificial intelligence component 112 is less likely to be implemented to assist at answering the calls.

Alternatively, or in addition, adjusting the computing process to increase the human-in-the-loop component usage relative to the artificial intelligence component usage (e.g., at the block 306) may comprise the controller 218, and/or the computing device 102: deactivating one or more given artificial intelligence based features of the computing process. For example, when an AI component 112 is implementing two or more features of an application 108, such as selecting police officers to be dispatched to an incident, and subsequently dispatching the police officers to the incident, the controller 218, and/or the computing device 102 may deactivate the selecting police officers feature, but not the dispatching the police officers to the incident feature. In other words, the selecting police officers may occur manually via respective HIL component 110 and, after the police officers are manually selected, the AI component 112 may dispatch the police officers to the incident.

Alternatively, or in addition, adjusting the computing process to increase the human-in-the-loop component usage relative to the artificial intelligence component usage (e.g., at the block 306) may comprise the controller 218, and/or the computing device 102 performing one or more of: changing a type of artificial intelligence algorithm used in the computing process from a theory-of-mind type artificial intelligence algorithm to a limited-memory artificial type intelligence algorithm or a reactive type artificial intelligence algorithm; changing the type of artificial intelligence algorithm used in the computing process from the limited-memory type artificial intelligence algorithm to the reactive type artificial intelligence algorithm; changing the type of artificial intelligence algorithm used in the computing process from a deep learning type artificial intelligence algorithm to a machine-learning type artificial intelligence algorithm; changing the type of artificial intelligence algorithm used in the computing process from a continuous-learning type artificial intelligence algorithm to a pre-trained type artificial intelligence algorithm; changing the type of artificial intelligence algorithm used in the computing process from an unsupervised-learning type artificial intelligence algorithm to a supervised-learning type artificial intelligence algorithm; and replacing the artificial intelligence algorithm with a programming-based algorithm.

For example, it is understood that artificial intelligence algorithms may be classified into various categories ranked according to complexity, interpretability, amongst other possibilities. For example, in order, reactive AI, limited memory AI, theory of mind AI and self-aware AI may have increasing complexity and/or decreasing interpretability. Indeed, a given AI component 112 may include different modules for implementing two or more of a reactive AI, a limited memory AI, a theory of mind AI and a self-aware AI and, when determining a relative weightage of human-in-the-loop component usage to artificial intelligence component usage in a computing process (e.g., at the block 302), reactive AI may be assigned a lower weight than a limited memory AI, which may be assigned a lower weight than a theory of mind AI, which may be assigned a lower weight than a self-aware AI.

For example, when determining a human-in-the-loop component usage relative to an artificial intelligence component usage, when an AI component 112 is implementing a reactive AI, the relative weightage of HIL component usage relative to AI component usage may be higher than when an AI component 112 is implementing a limited memory AI, even when the HIL component usage is otherwise the same or similar.

Similarly, when determining a human-in-the-loop component usage relative to an artificial intelligence component usage, when an AI component 112 is implementing a limited memory AI, the relative weightage of HIL component usage relative to AI component usage may be higher than when an AI component 112 is implementing a theory-of-mind AI, even when the HIL component usage is otherwise the same or similar.

Similarly, when determining a human-in-the-loop component usage relative to an artificial intelligence component usage, when an AI component 112 is implementing a theory-of-mind AI, the relative weightage of HIL component usage relative to AI component usage may be higher than when an AI component 112 is implementing a self-aware AI, even when the HIL component usage is otherwise the same or similar.

It is further noted that while herein the changes in relative weightage includes a discussion of self-aware AI, such self-aware AI is, at the moment, theoretical; however a person-of-skill in the art may understand that development of such self-aware AI is likely to occur.

Hence, to increase human-in-the-loop component usage relative to the artificial intelligence component usage, the controller 218, and/or the computing device 102 may change a type of artificial intelligence algorithm used in the computing process from a theory-of-mind type artificial intelligence algorithm to a limited-memory artificial type intelligence algorithm or a reactive type artificial intelligence algorithm, for example, by deactivating a module of an AI component 112 implementing a theory-of-mind type artificial intelligence algorithm and activating a respective module that implements a limited-memory artificial type intelligence algorithm or a reactive type artificial intelligence algorithm.

Similarly, to increase human-in-the-loop component usage relative to the artificial intelligence component usage, the controller 218, and/or the computing device 102 may change a type of artificial intelligence algorithm used in the computing process from a limited-memory type artificial intelligence algorithm to a reactive type artificial intelligence algorithm, for example, by deactivating a module of an AI component 112 implementing a limited-memory type artificial intelligence algorithm and activating a respective module that implements a reactive type artificial intelligence algorithm.

Similar weights may also be assigned to more specific types of AI.

For example, deep learning type artificial intelligence algorithm may be weighted higher than a machine-learning type artificial intelligence algorithm. As such, when determining a human-in-the-loop component usage relative to an artificial intelligence component usage, when an AI component 112 is implementing a deep learning type artificial intelligence, the relative weightage of HIL component usage relative to AI component usage may be lower than when an AI component 112 is implementing a machine-learning type artificial intelligence algorithm, even when the HIL component usage is otherwise the same or similar.

Hence, in these examples, to increase human-in-the-loop component usage relative to the artificial intelligence component usage, the controller 218, and/or the computing device 102 may change a type of artificial intelligence algorithm used in the computing process from a deep learning type artificial intelligence algorithm to a machine-learning type artificial intelligence algorithm, for example, by deactivating a module of an AI component 112 implementing a deep learning type artificial intelligence algorithm and activating a respective module that implements a machine-learning type artificial intelligence algorithm.

Similarly, a continuous-learning type artificial intelligence algorithm may be weighted higher than a pre-trained type artificial intelligence algorithm. As such, when determining a human-in-the-loop component usage relative to an artificial intelligence component usage, when an AI component 112 is implementing a continuous-learning type artificial intelligence, the relative weightage of HIL component usage relative to AI component usage may be lower than when an AI component 112 is implementing a pre-trained type artificial intelligence algorithm, even when the HIL component usage is otherwise the same or similar.

Hence, in these examples, to increase human-in-the-loop component usage relative to the artificial intelligence component usage, the controller 218, and/or the computing device 102 may change a type of artificial intelligence algorithm used in the computing process from a continuous-learning type artificial intelligence algorithm to a pre-trained type artificial intelligence algorithm, for example, by deactivating a module of an AI component 112 implementing a continuous-learning type artificial intelligence algorithm and activating a respective module that respective module implementing a pre-trained type artificial intelligence algorithm.

Similarly, an unsupervised-learning type artificial intelligence algorithm may be weighted higher than a supervised-learning type artificial intelligence algorithm. As such, when determining a human-in-the-loop component usage relative to an artificial intelligence component usage, when an AI component 112 is implementing an unsupervised-learning type artificial intelligence algorithm, the relative weightage of HIL component usage relative to AI component usage may be lower than when an AI component 112 is implementing a supervised-learning type artificial intelligence algorithm, even when the HIL component usage is otherwise the same or similar.

Hence, in these examples, to increase human-in-the-loop component usage relative to the artificial intelligence component usage, the controller 218, and/or the computing device 102 may change a type of artificial intelligence algorithm used in the computing process from an unsupervised-learning type artificial intelligence algorithm to a supervised-learning type artificial intelligence algorithm, for example, by deactivating a module of an AI component 112 implementing an unsupervised-learning type artificial intelligence algorithm and activating a respective module that respective module implementing a supervised-learning type artificial intelligence algorithm.

In yet further examples, an AI component 112 may include one or more programming-based algorithm modules, which may implement functionality of the AI component 112 via more traditional programming logic, as well as one or more AI modules. In these examples, to adjust the computing process of the AI component 112 to increase the human-in-the-loop component usage relative to the artificial intelligence component usage, an AI module may be deactivated and a corresponding programming-based algorithm module that implements similar functionality (e.g., to replace an artificial intelligence algorithm with a programming-based algorithm).

In yet further examples, adjusting the computing process to decrease the human-in-the-loop component usage relative to the artificial intelligence component usage (e.g., at the block 308) may comprise the controller 218, and/or the computing device 102: decreasing a threshold 120 in the computing process for implementing an artificial intelligence component. In particular a threshold 120 may be decreased such that an artificial intelligence component 112 is more likely to be implemented.

Alternatively, or in addition, adjusting the computing process to decrease the human-in-the-loop component usage relative to the artificial intelligence component usage (e.g., at the block 308) may comprise the controller 218, and/or the computing device 102: adjusting the computing process to decrease the human-in-the-loop component usage relative to the artificial intelligence component usage may comprise the controller 218, and/or the computing device 102: activating one or more given artificial intelligence based features of the computing process. For example when only one feature of an AI component 112 is initially being implemented, one more or more additional given artificial intelligence based features of the AI component 112 may be activated.

Changing types of AI algorithms to increase the human-in-the-loop component usage relative to the artificial intelligence component usage has already been described, as has replacing an artificial intelligence algorithm with a programming-based algorithm. Hence, to decrease the human-in-the-loop component usage relative to the artificial intelligence component usage, reverse actions may be implemented by the controller 218 and/or the computing device 102.

For example, adjusting the computing process to decrease the human-in-the-loop component usage relative to the artificial intelligence component usage (e.g., at the block 308) may comprise the controller 218, and/or the computing device 102 performing one or more of: changing a type of artificial intelligence algorithm used in the computing process from a reactive type artificial intelligence algorithm to a limited-memory artificial type intelligence algorithm or a theory-of-mind type artificial intelligence algorithm; changing the type of artificial intelligence algorithm used in the computing process from the limited-memory type artificial intelligence algorithm to the theory-of-mind type artificial intelligence algorithm; changing the type of artificial intelligence algorithm used in the computing process from a machine-learning type artificial intelligence algorithm to a deep learning type artificial intelligence algorithm; changing the type of artificial intelligence algorithm used in the computing process from a pre-trained type artificial intelligence algorithm to a continuous-learning type artificial intelligence algorithm; changing the type of artificial intelligence algorithm used in the computing process from a supervised-learning type artificial intelligence algorithm to an unsupervised-learning type artificial intelligence algorithm; and replacing a programming-based algorithm with the artificial intelligence algorithm. Such changing AI algorithm types and/or replacing a programming-based algorithm with the artificial intelligence algorithm, may occur via activating and deactivating modules of an AI component 112.

However, it is understood that a relative weightage of human-in-the-loop component usage to artificial intelligence component usage in a computing process that includes human decision-making and artificial intelligence decision-making may occur in any suitable manner, for example to bring the relative weightage into the given range 124.

Furthermore, when controlling an AI component 112 associated with a client device 104, as described herein, the controller 218 and/or the computing device 102 may provide one or more commands to the client device 104 to cause the client device 104 to control the AI component 112 accordingly.

Furthermore, in some examples, (e.g., prior to the block 306 or the block 308, and/or performed in conjunction with the block 306 and/or the block 308) adjusting the computing process to increase or decrease the human-in-the-loop component usage relative to the artificial intelligence component usage may comprise the controller 218 and/or the computing device 102: controlling a notification device to provide an indication of the adjusting; receiving, from a client device 104 associated with the notification device, an acceptance of the adjusting; and implementing the adjusting in response to receiving the acceptance. Such a notification device may comprise a respective display screen 114, and/or a speaker of the client device 104 (e.g., and voice commands may be used to provide an acceptance of the adjusting).

Put another way, prior to adjusting the computing process to increase or decrease the human-in-the-loop component usage relative to the artificial intelligence component usage for a particular client device 104, at a notification device of the particular client device 104, such as a respective display screen 114, an indication of the adjusting is provided, such as a proposed increase or decrease to a threshold 120, proposed AI-based features that are to be deactivated or activated, proposed types of AI algorithms that are to be changed, and the like. A user 106 may review the proposed adjustments to the computing process and accept or reject the proposed adjustments, for example via operation of a respective input device 116 to activate an “accept” or “reject” electronic button. In these examples, the proposed adjustments may be implemented when an acceptance is received; conversely, the proposed adjustments may not be implemented when a rejection is received. However, in some scenarios where the system 100 must conform with legislation governing the usage of AI, a rejection may be permitted only when the relative weightage is below the given range 124.

In some examples, the method 300 may further comprise the controller 218 and/or the computing device 102: adjusting the given range 124, for example based on one or more factors associated with implementing a computing process. For example a given range 124 may be adjusted (e.g., lowered, raised, narrowed, widened) based on new legislation that governs AI usage for a particular computing process and/or a given range 124 may be adjusted when errors in AI decisions are determined to occur (e.g., the given range 124 may be increased, widened, narrowed, and the like, to increase the human-in-the-loop component usage relative to the AI component usage, for example). Put another way, the controller 218 and/or the computing device 102 may: determine when error in AI decisions occur for a given application 108, for example by tracking how often declining of an AI decision occurs by an associated user 106; and, when errors in AI decisions are above a threshold error rate (e.g., 5%, 10%, 15% of AI decisions are declined), increase the given range 124.

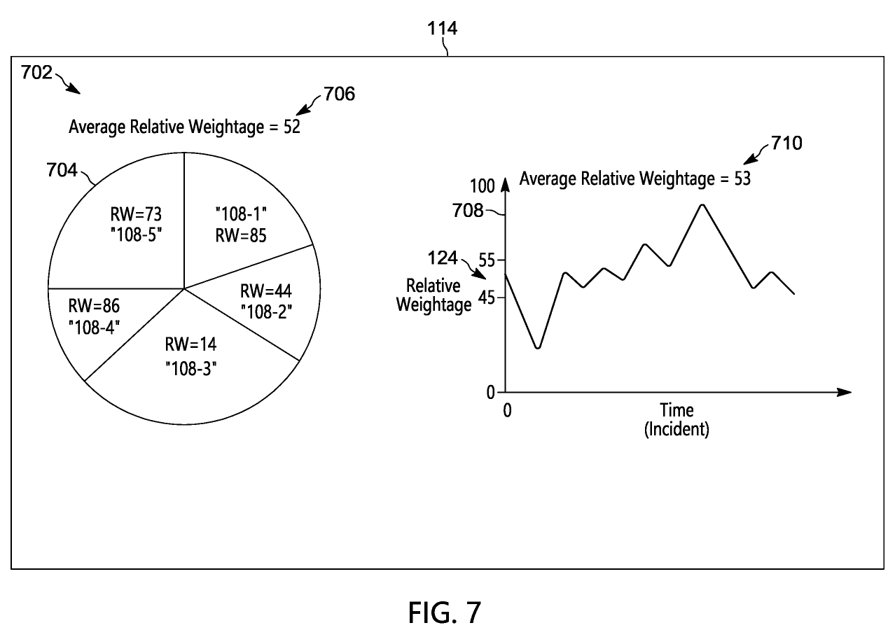

In some examples, the method 300 may further comprise the controller 218 and/or the computing device 102: generating a dashboard at a display screen 114, the dashboard providing indications of the adjusting of the block 306 and/or the block 308. An example of such a dashboard is depicted in FIG. 7.

In some examples, the relative weightage may be based on respective human-in-the-loop component usage to respective artificial intelligence component usage for a plurality of computing processes (e.g., including the computing process of the block 302), and the method 300 may further comprise the controller 218 and/or the computing device 102: adjusting one or more the plurality of computing processes (e.g., one or more of the plurality of applications 108) to increase or decrease the respective human-in-the-loop component usage relative to the respective artificial intelligence component usage, to bring the relative weightage to within the given range 124. Put another way, each of the plurality of applications 108 may be adjusted individually to bring respective relative weightages to within the given range 124.

Alternatively, the relative weightage may comprise an average relative weightage, based on average, or total, human-in-the-loop component usage to (respectively) average, or total, artificial intelligence component usage for a plurality of computing processes (e.g., including the computing process of the block 302), and the method 300 may further comprise the controller 218 and/or the computing device 102: adjusting one or more the plurality of computing processes to increase or decrease respective human-in-the-loop component usage relative to respective artificial intelligence component usage, to bring the average relative weightage, for the plurality of computing processes, to within the given range 124. Put another way, each of the plurality of applications 108 may be adjusted individually to bring an average relative weightage to within the given range 124.

In yet further examples, the relative weightage may comprise an average relative weightage, based on average, or total, human-in-the-loop component usage to (respectively) average, or total, artificial intelligence component usage for a plurality of computing processes, including the computing process, that occur at different stages of an incident response, and the method 300 may further comprises the controller 218, and/or the computing device 102: adjusting one or more the plurality of computing processes to increase or decrease respective human-in-the-loop component usage relative to respective artificial intelligence component usage, to bring the relative weightage, for the plurality of computing processes, to within the given range 124.

For example, different applications 108 may be implemented in the system 100 at different stages of an incident response (e.g., a call application 108, an officer selection application 108, a dispatch application 108, a navigation application 108, a report writing application 108 and a crime analysis application 108), and as the incident response progresses, the controller 218, and/or the computing device 102, adjust computing processes of the different applications 108 to bring an average, and/or a running average, of the relative weightage of the different applications 108 to within the given range 124.

However, in some examples, the relative weightage being below the given range 124 may be at least temporarily permitted for some applications 108 used in the incident response (e.g., to increase AI component usage), for example when call volume at PSAP is above a threshold call volume (e.g., a threshold 120 may comprise a threshold call volume of 10, 15 or 20 calls per minute, amongst other possibilities). However, in these examples, relative weightage of applications 108 used later in the incident response, such as report writing applications 108 and/or crime analysis applications 108, may be controlled to be above the given range 124 (e.g., to increase HIL component usage) to bring an average relative weightage for the incident response into the given range 124.

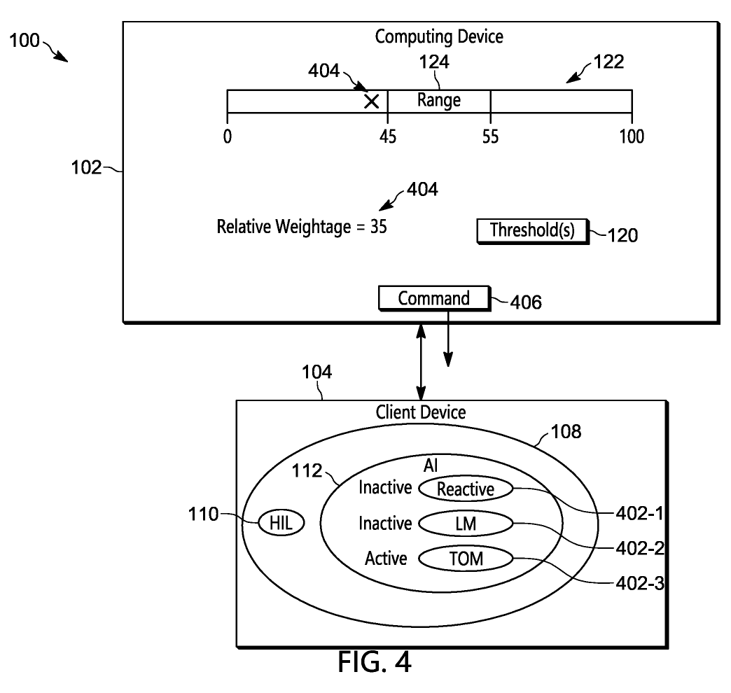

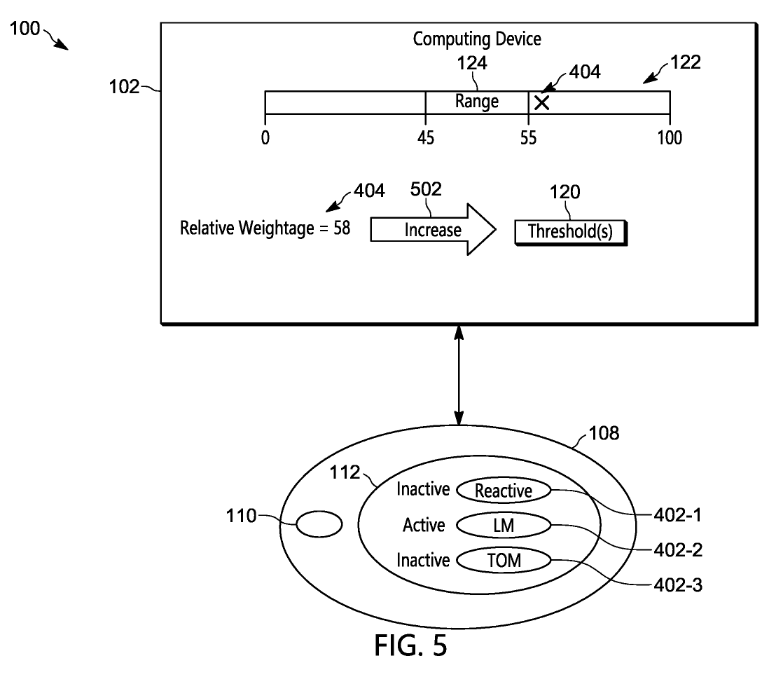

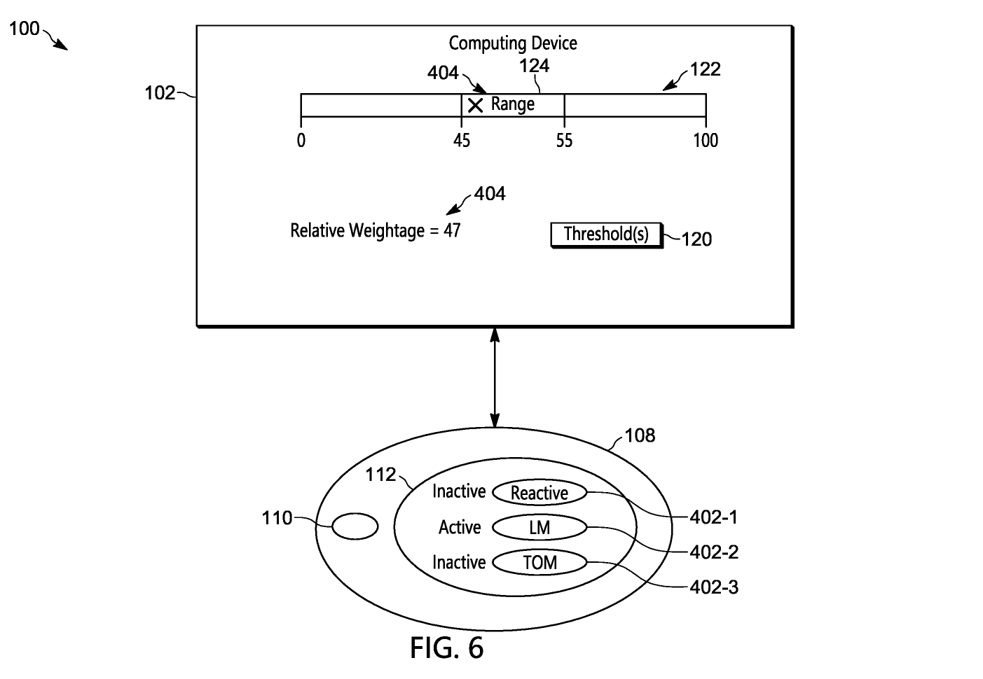

Attention is next directed to FIG. 4, FIG. 5, and FIG. 6 which depict a portion of the system 100 implementing the method 300. In particular, FIG. 4, FIG. 5, and FIG. 6 depict the computing device 104 in communication with a client device 104 implementing an instance of an application 108 that includes a respective HIL component 110 and a respective AI component 112. While not all the client devices 104 of the system 100 are depicted for simplicity, they may nonetheless be present.

With attention directed to FIG. 4, it is understood that the AI component 112 comprises three AI modules to implement different AI types, including a reactive AI module 402-1, a limited memory (LM) AI module 402-2, and a theory-of-mind (TOM) AI module 402-3 (e.g., AI modules 402 and/or an AI module 402). It is understood that, as depicted, the TOM AI module 402-3 is active while the remaining AI modules 402-1, 402-2 are inactive (e.g., as indicated in FIG. 4 via the terms “ACTIVE” or “INACTIVE” adjacent the AI modules 402).

Furthermore, as depicted, the computing device 104 determines (e.g., at the block 302 of the method 300) a relative weightage 404 of human-in-the-loop component usage to artificial intelligence component usage in a computing process of the application 108 that includes human decision-making and artificial intelligence decision-making, as has been described herein. While not depicted, it is understood that the relative weightage 404 may be determined from data provided by the application 108, and/or the client device 104 implementing the application 108, and such data may indicate usage of the HIL component 110 and usage of the AI component 112 (e.g., as well which of the modules 402 is active). Alternatively, or in addition, the relative weightage 404 may be determined by the application 108, and/or the client device 104, and provided to the computing device 104.

As depicted the relative weightage 404 is “35”, which is below the given range 124 of “45” to “55”. For clarity, the relative weightage 404 of “35” is also indicated on the scale 122 via an “X”. As such, the computing device 102 may determine (e.g., at the block 304 of the method 300), that the relative weightage 404 is below the given range 124, generally indicating that AI decisions may be overly relied on in the system 100, and/or, more specifically, at the depicted client device 104.

To attempt to bring the relative weightage 404 to within the given range 124, the computing device 102 generates and provides a command 406 to the client device 104 and/or the application 108, to adjust (e.g., at the block 306 of the method 300) the computing process of the application 108 to increase the human-in-the-loop component usage relative to the artificial intelligence component usage, for example by deactivating the TOM AI module 402-3 and activating the LM AI module 402-2.

Attention is next directed to FIG. 5, which depicts the TOM AI module 402-3 deactivated and the LM AI module 402-2 activated. The computing device 102 again determines (e.g., at the block 302 of the method 300) the relative weightage 404 and, as depicted, the relative weightage 404 has changed to “58”. The computing device 102 determines (e.g., at the block 304 of the method 300), that the relative weightage 404 is above the given range 124. Hence, the system 100 may be insufficiently using AI, which may reduce the efficiency of operations of the system 100.

To attempt to bring the relative weightage 404 to within the given range 124, the computing device 102 adjusts (e.g., at the block 308 of the method 300) the computing process of the application 108 to decrease the human-in-the-loop component usage relative to the artificial intelligence component usage, for example by increasing (e.g., as represented by an arrow 502) a threshold 120 for implementing the AI component 112 of the application 108.

Attention is next directed to FIG. 6, which depicts the portion of the system 100 after the threshold 120 for implementing the AI component 112 of the application 108 is increased. In particular, the computing device 102 again determines (e.g., at the block 302 of the method 300) the relative weightage 404 and, as depicted, the relative weightage 404 has changed to “47”. The computing device 102 determines (e.g., at the block 304 of the method 300), that the relative weightage 404 is within the given range 124. Hence, the system 100 may be sufficiently balancing use of AI and human-made decisions. The computing device 102 may continue to monitor the relative weightage 404 and again adjust the computing process of the application 108 when the relative weightage 404 falls outside of the given range 124.

Furthermore, it is understood that the computing process of the application 108 may be adjusted in any given manner. For example, while in the depicted example, the computing device 102 first activates a different AI module 402 to attempt to bring the relative weightage 404 into the given range 124, and later adjusts a threshold 120, the computing device 102 may implement any suitable set of actions, in any suitable order to attempt to bring the relative weightage 404 into the given range 124. For example, with reference to FIG. 5, rather than adjust the threshold 120, the computing device 102 may deactivate the LM AI module 402-2 and activate the reactive AI module 402-1 and, when the relative weightage 404 is still not in the given range, the computing device 102 may later adjust a threshold 120 accordingly. Alternatively, adjustment of a threshold 120 may occur prior to activating different AI modules 402, and/or in conjunction with activating different AI modules 402. Furthermore adjustment of a threshold 120 may occur in predefined steps, as steps of 5%, 10%, 15%, amongst other possibilities, of a current threshold value to attempt to raise or lower the relative weightage 404.

Attention is next directed to FIG. 7, which depicts an example of a dashboard 702 provided at a display screen 114, the dashboard 702 providing indications of adjusting one or more computing processes of respective applications 108 to increase or decrease the human-in-the-loop component usage relative to the artificial intelligence component usage.

In particular, the dashboard 702 includes a chart 704 showing relative weightage (abbreviated as “RW” in the chart 704) for a plurality of applications 108 (e.g., applications 108-1, 108-2, 108-3, 108-4, 108-5 as indicated by respective indicators “108-1”, “108-2”, “108-3”, “108-4”, “108-5”), for example over a given time period, such as one day, one week, one month, amongst other possibilities. Indeed, in some examples, the given time period may be selectable at the dashboard 702. Furthermore, the chart 704, which is a form of a pie chart, shows relative usage of the applications 108 over the given time period, each of which corresponds to a wedge of the chart 704, as presented by respective area of a respective wedge. For example, in order, the applications 108-3, 108-5, 108-1, 108-2, 108-4 may be weighted from highest to lowest usage.

Furthermore, the relative weightage of the applications 108-1, 108-2, 108-3, 108-4, 108-5 is, respectively, “85”, “44”, “14”, “86” and “73”. Of these relative weightages, none are in the given range 124.

However, as also depicted at the dashboard 702, and taking into account the relative usage, an average relative weightage 706 of the plurality of the applications 108, over the given time period, is “52”, which is in the given range 124.

Hence it is understood that the computing device 102 may adjust the respective computing processes of the depicted applications 108, over the given time period, to keep the average relative weightage 706 within the given range 124, rather than more specifically attempt to keep the respective relative weightages (e.g., of each application 108) within the given range 124. Indeed, as respective relative weightage each of the depicted applications 108 may be allowed to deviate from the given range 124 under certain conditions (e.g., such as call volume being above a threshold call volume), the system 100 may attempt to control AI usage via controlling the overall average relative weightage and/or a running average relative weightage, and the like. For example, as the application 108-3 has a relative weightage of “14”, which is below the given range 124, indicating possible over use of AI, the application 108-1 may be controlled to operate according to a relative weightage that is higher than the given range 124 (e.g., “85”) to balance out the over use of AI by the application 108-3.

As depicted, the dashboard 702 further comprises a graph 708 for a given incident, showing average relative weightage of one or more of the applications 108 over a time period of the given incident. The given range 124 is also depicted. As depicted, the average relative weightage is within the given range 124, but decreases to out of the given range 124 (e.g., indicating possible overuse of AI in the system 100, for the given incident, such as during a time period where call volume is high), later increasing to back within the given range 124. To balance out usage of AI for the incident, the average relative weightage is later controlled to be higher than the given range 124, at least for a time period, for example when an incident report is being written, and finally decreasing back to within the given range 124. The average relative weightage 710 over the incident response is also shown as “53”, indicating that the average relative weightage of the applications 108 were controlled over the incident response to be within the given range 124.

The dashboard 702 may comprise any other suitable indications of adjusting computing processes of the system 100 to control relative weightage, including, but not limited to, a breakdown of AI task type for individual applications 108, and/or for a plurality of the applications 108, and associated relative weightages. Such breakdowns may alternatively, or in addition, include breakdowns of HIL component usage relative to AI component usage for AI task type for individual applications 108, and/or for the plurality of the applications 108 (e.g. with or without including indications of adjusting computing processes of the system 100 to control relative weightage).

While certain types of the applications 108 have been previously described, types of applications 108 that may be referenced at the dashboard 702 may include any suitable types and may include, but are not limited to: report writing applications, navigation applications, dispatching applications, 911 call taking applications, pursuit applications, PSAP applications, call handling applications (e.g. such as VESTA™ NG911TM from Motorola Solutions Inc.™ (MSI™), amongst other possibilities), command center applications (e.g., such as CommandCentral AWARE™ from MSI™, amongst other possibilities), computer-aided dispatch applications (e.g., such as PremierOne™ from MSI™, amongst other possibilities), workflow applications (e.g., such as Orchestrate™ from MSI™ amongst other possibilities), crime analyst applications, and the like.

Alternatively, or in addition, the dashboard 702 may comprise any other suitable indications of adjusting computing processes of the system 100 to control relative weightage, including, but not limited to, a breakdown of usage of the plurality of the AI types of the AI components 112. Such breakdowns may alternatively, or in addition, include breakdowns of HIL component usage relative to AI component usage for AI types of the AI components 112 (e.g., with or without including indications of adjusting computing processes of the system 100 to control relative weightage).

Alternatively, or in addition, the dashboard 702 may comprise a breakdown of HIL component usage relative to AI component usage, and the like, for a plurality of incident types and/or HIL component usage relative to AI component usage for different incident types (e.g., with or without including indications of adjusting computing processes of the system 100 to control relative weightage). Such incident types may include, but are not limited to, murder incidents, domestic violence incidents, robbery incidents, theft incidents, fire incidents, amongst other possibilities.

Alternatively, or in addition, the dashboard 702 may comprise a breakdown of HIL component usage relative to AI component usage, and the like, for a plurality of AI impact categories and/or HIL component usage relative to AI component usage for different AI impact categories, (with or without including indications of adjusting computing processes of the system 100 to control relative weightage). In particular, the applications 108 may be classified according to different categories that may include, but are not limited to, safety, privacy, bias, amongst other possibilities, indicating whether an application 108 is respectively related to safety, privacy, bias (e.g. removing bias), and an AI impact category may be understood to indicate how AI component usage might impact a given category of application 108.

Alternatively, or in addition, the dashboard 702 may comprise a breakdown of HIL component usage relative to AI component usage, and the like, for different types of public safety agencies and/or public safety departments and/or different locations and/or different jurisdictions. Such a breakdown may alternatively, or in addition, include a breakdown of HIL component usage relative to AI component usage for different types of public safety agencies and/or public safety departments and/or different locations and/or different jurisdictions (e.g., with or without including indications of adjusting computing processes of the system 100 to control relative weightage). Such agencies and/or departments may include, but are not limited to, police agencies and/or police departments, fire agencies and/or fire departments, medical agencies and/or medical departments, hospital agencies and/or hospital departments, forensic agencies and/or forensic departments (e.g. of police agencies and/or medical agencies and/or hospital agencies), crime investigation agencies and/or crime investigation departments (e.g., of police agencies), traffic agencies and/or traffic departments department, (e.g., of police agencies), and the like, amongst other possibilities.

Furthermore, the dashboard 702 may include a breakdown of relative weightage, and the like, for an incident according to time periods corresponding to pre-incident, during incident and post-incident. However, any suitable information may be provided at the dashboard 702, which may enable analysis of HIL component usage relative to AI component usage in the system 100.

In specific examples, HIL component usage and/or AI component usage may be indicated at a report (e.g., police report) being written using the computing device 102 and/or a client device 104, and displayed at a display screen (e.g. a display screen 114), such that words, phrases and/or sentences written in the report that involve the AI component usage may be annotated to indicate AI component usage. For example, words, phrases and/or sentences may be highlighted and/or underlined and/or color-coded and/or use a different text and/or font to indicate that such words, phrases and/or sentences describe actions by police officers that were assisted by and/or involved an AI component 112. Put another way, words, phrases and/or sentences that describe human actions (for example, an action performed by a police officer) that were assisted by an AI component 112 may appear differently in the report from words, phrases and/or sentences generated using an HIL component 110.

In a specific example, a sentence in a police report of “I found Suspect Smith is running on the Queensbay Road” may be highlighted in yellow, indicating that the police action of detection of suspect Smith was assisted using facial recognition via deep learning AI applied to images and/or video from a body worn camera (BWC) worn by a police officer generating the report. In this specific example, a relative weightage (e.g. of HIL component usage relative to AI component usage, as described herein), may be indicated in association with the aforementioned sentence in the police report, with an option for the police officer (e.g., or any other suitable user) to double click on the sentence and/or the relative weightage, and the like, which may cause details of how the relative weightage was determined to be provided at the display screen 114 and/or details of HIL component usage and/or AI component usage (e.g., what type of AI was used for the facial recognition, amongst other possibilities).

Continuing with this example, a recommendation may be provided at the display screen 114, to the police officer, when a provided relative weightage is not in the given range 124, for example to better review items associated with the police report, along with options for performing such a review. For example, when an AI component 112 was used to identify the suspect using the images and/or video from the BWC, and the relative weightage is above the given range 124, a recommendation to review the images and/or video may be provided along with controls to view and/or zoom and/or pan images and/or video of the suspect to increase the HIL component usage. Once the images and/or video are reviewed, the police officer may either accept AI generated content (e.g., such as a name of the identified suspect) or change the AI generated content based on the review (e.g., the police officer may determine that the suspect has been erroneously identified as “Smith” and change the AI generated content to another suspect name, or indicate that the suspect has not been identified).

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, implement AI and/or change AI components, generate dashboards, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the "C" programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining, at a computing device, a relative weightage of human-in-the-loop component usage to artificial intelligence component usage in a computing process that includes human decision-making and artificial intelligence decision-making;
when the relative weightage is below a given range, such that the human-in-the-loop component usage is low relative to the artificial intelligence component usage: adjusting, via the computing device, the computing process to increase the human-in-the-loop component usage relative to the artificial intelligence component usage; and
when the relative weightage is above the given range, such that the human-in-the-loop component usage is high relative to the artificial intelligence component usage: adjusting, via the computing device, the computing process to decrease the human-in-the-loop component usage relative to the artificial intelligence component usage.

2. The method of claim 1, wherein adjusting the computing process to increase the human-in-the-loop component usage relative to the artificial intelligence component usage comprises:
increasing a threshold in the computing process for implementing an artificial intelligence component.

3. The method of claim 1, wherein adjusting the computing process to increase the human-in-the-loop component usage relative to the artificial intelligence component usage comprises:
deactivating one or more given artificial intelligence based features of the computing process.

4. The method of claim 1, wherein adjusting the computing process to increase the human-in-the-loop component usage relative to the artificial intelligence component usage comprises one or more of:
changing a type of artificial intelligence algorithm used in the computing process from a theory-of-mind type artificial intelligence algorithm to a limited-memory artificial type intelligence algorithm or a reactive type artificial intelligence algorithm;
changing the type of artificial intelligence algorithm used in the computing process from the limited-memory type artificial intelligence algorithm to the reactive type artificial intelligence algorithm;
changing the type of artificial intelligence algorithm used in the computing process from a deep learning type artificial intelligence algorithm to a machine-learning type artificial intelligence algorithm;
changing the type of artificial intelligence algorithm used in the computing process from a continuous-learning type artificial intelligence algorithm to a pre-trained type artificial intelligence algorithm;
changing the type of artificial intelligence algorithm used in the computing process from an unsupervised-learning type artificial intelligence algorithm to a supervised-learning type artificial intelligence algorithm;
and
replacing the artificial intelligence algorithm with a programming-based algorithm.

5. The method of claim 1, wherein adjusting the computing process to decrease the human-in-the-loop component usage relative to the artificial intelligence component usage comprises:
decreasing a threshold in the computing process for implementing an artificial intelligence component.

6. The method of claim 1, wherein adjusting the computing process to decrease the human-in-the-loop component usage relative to the artificial intelligence component usage comprises:
activating one or more given artificial intelligence based features of the computing process.

7. The method of claim 1, wherein adjusting the computing process to decrease the human-in-the-loop component usage relative to the artificial intelligence component usage comprises one or more of:
changing a type of artificial intelligence algorithm used in the computing process from a reactive type artificial intelligence algorithm to a limited-memory artificial type intelligence algorithm or a theory-of-mind type artificial intelligence algorithm;
changing the type of artificial intelligence algorithm used in the computing process from the limited-memory type artificial intelligence algorithm to the theory-of-mind type artificial intelligence algorithm;
changing the type of artificial intelligence algorithm used in the computing process from a machine-learning type artificial intelligence algorithm to a deep learning type artificial intelligence algorithm;
changing the type of artificial intelligence algorithm used in the computing process from a pre-trained type artificial intelligence algorithm to a continuous-learning type artificial intelligence algorithm;
changing the type of artificial intelligence algorithm used in the computing process from a supervised-learning type artificial intelligence algorithm to an unsupervised-learning type artificial intelligence algorithm;
and
replacing a programming-based algorithm with the artificial intelligence algorithm.

8. The method of claim 1, wherein adjusting the computing process to increase or decrease the human-in-the-loop component usage relative to the artificial intelligence component usage comprises:
controlling a notification device to provide an indication of the adjusting;
receiving, from a client device associated with the notification device, an acceptance of the adjusting; and
implementing the adjusting in response to receiving the acceptance.

9. The method of claim 1, further comprising:
adjusting the given range based on one or more factors associated with implementing the computing process.

10. The method of claim 1, further comprising one or more of:
generating a dashboard at a display screen, the dashboard providing indications of the adjusting; and
generating an incident report at the display screen, the incident report providing one or more indications at text of the incident screen that describe respective human actions that were assisted by the artificial intelligence component.

11. The method of claim 1, wherein the relative weightage comprises an average relative weightage, based on average, or total, human-in-the-loop component usage to average, or total, artificial intelligence component usage for a plurality of computing processes, including the computing process, that occur at different stages of an incident response, and the method further comprises:
adjusting one or more the plurality of computing processes to increase or decrease respective human-in-the-loop component usage relative to respective artificial intelligence component usage, to bring the average relative weightage, for the plurality of computing processes, to within the given range.

12. The method of claim 1, wherein the relative weightage comprises an average relative weightage, based on average, or total, human-in-the-loop component usage to average, or total, artificial intelligence component usage for a plurality of computing processes, including the computing process, that occur at different stages of an incident response, and the method further comprises:
adjusting one or more the plurality of computing processes to increase or decrease respective human-in-the-loop component usage relative to respective artificial intelligence component usage, to bring the relative weightage, for the plurality of computing processes, to within the given range.

13. A computing device comprising:
a controller; and
a computer-readable storage medium having stored thereon program instructions that, when executed by the controller, causes the controller to perform a set of operations comprising:
determining a relative weightage of human-in-the-loop component usage to artificial intelligence component usage in a computing process that includes human decision-making and artificial intelligence decision-making;
when the relative weightage is below a given range, such that the human-in-the-loop component usage is low relative to the artificial intelligence component usage: adjusting the computing process to increase the human-in-the-loop component usage relative to the artificial intelligence component usage; and
when the relative weightage is above the given range, such that the human-in-the-loop component usage is high relative to the artificial intelligence component usage: adjusting the computing process to decrease the human-in-the-loop component usage relative to the artificial intelligence component usage.

14. The computing device of claim 13, wherein adjusting the computing process to increase the human-in-the-loop component usage relative to the artificial intelligence component usage comprises one or more of:
increasing a threshold in the computing process for implementing an artificial intelligence component;
deactivating one or more given artificial intelligence based features of the computing process.
changing a type of artificial intelligence algorithm used in the computing process from a theory-of-mind type artificial intelligence algorithm to a limited-memory artificial type intelligence algorithm or a reactive type artificial intelligence algorithm;
changing the type of artificial intelligence algorithm used in the computing process from the limited-memory type artificial intelligence algorithm to the reactive type artificial intelligence algorithm;
changing the type of artificial intelligence algorithm used in the computing process from a deep learning type artificial intelligence algorithm to a machine-learning type artificial intelligence algorithm;
changing the type of artificial intelligence algorithm used in the computing process from a continuous-learning type artificial intelligence algorithm to a pre-trained type artificial intelligence algorithm;
changing the type of artificial intelligence algorithm used in the computing process from an unsupervised-learning type artificial intelligence algorithm to a supervised-learning type artificial intelligence algorithm;
and
replacing the artificial intelligence algorithm with a programming-based algorithm;

15. The computing device of claim 13, wherein adjusting the computing process to decrease the human-in-the-loop component usage relative to the artificial intelligence component usage comprises one or more of:
decreasing a threshold in the computing process for implementing an artificial intelligence component;
activating one or more given artificial intelligence based features of the computing process;
changing a type of artificial intelligence algorithm used in the computing process from a reactive type artificial intelligence algorithm to a limited-memory artificial type intelligence algorithm or a theory-of-mind type artificial intelligence algorithm;
changing the type of artificial intelligence algorithm used in the computing process from the limited-memory type artificial intelligence algorithm to the theory-of-mind type artificial intelligence algorithm;
changing the type of artificial intelligence algorithm used in the computing process from a machine-learning type artificial intelligence algorithm to a deep learning type artificial intelligence algorithm;
changing the type of artificial intelligence algorithm used in the computing process from a pre-trained type artificial intelligence algorithm to a continuous-learning type artificial intelligence algorithm;
changing the type of artificial intelligence algorithm used in the computing process from a supervised-learning type artificial intelligence algorithm to an unsupervised-learning type artificial intelligence algorithm;
and
replacing a programming-based algorithm with the artificial intelligence algorithm.

16. The computing device of claim 13, wherein adjusting the computing process to increase or decrease the human-in-the-loop component usage relative to the artificial intelligence component usage comprises:
controlling a notification device to provide an indication of the adjusting;
receiving, from a client device associated with the notification device, an acceptance of the adjusting; and
implementing the adjusting in response to receiving the acceptance.

17. The computing device of claim 13, wherein the set of operations further comprises:
adjusting the given range based on one or more factors associated with implementing the computing process.

18. The computing device of claim 13, wherein the set of operations further comprises one or more of:
generating a dashboard at a display screen, the dashboard providing indications of the adjusting; and
generating an incident report at the display screen, the incident report providing one or more indications at text of the incident screen that describe respective human actions that were assisted by the artificial intelligence component.

19. The computing device of claim 13, wherein the relative weightage comprises an average relative weightage, based on average, or total, human-in-the-loop component usage to average, or total, artificial intelligence component usage for a plurality of computing processes, including the computing process, that occur at different stages of an incident response, and the method further comprises:
adjusting one or more the plurality of computing processes to increase or decrease respective human-in-the-loop component usage relative to respective artificial intelligence component usage, to bring the average relative weightage, for the plurality of computing processes, to within the given range.

20. The computing device of claim 13, wherein the relative weightage comprises an average relative weightage, based on average, or total, human-in-the-loop component usage to average, or total, artificial intelligence component usage for a plurality of computing processes, including the computing process, that occur at different stages of an incident response, and the method further comprises:
adjusting one or more the plurality of computing processes to increase or decrease respective human-in-the-loop component usage relative to respective artificial intelligence component usage, to bring the relative weightage, for the plurality of computing processes, to within the given range.
